(19) United States
(12) Patent Application Publication
(10) Pub. No.: US 2011/0249817 A1
(43) Pub. Date: Oct. 13, 2011

(54) METHOD OF MANAGING GROUP KEY FOR SECURE MULTICAST COMMUNICATION

(75) Inventors: Jee Hyun Park, Daejeon (KR); Jung Hyun Kim, Daejeon (KR); Jung Soo Lee, Daejeon (KR); Yeon Jeong Jeong, Daejeon (KR); Do-Won Nam, Daejeon (KR); Kisong Yoon, Daejeon (KR)

(73) Assignee: Electronics and Telcommunications Research Institute, Daejeon (KR)

(21) Appl. No.: 13/133,920

(22) PCT Filed: May 13, 2009
(86) PCT No.: PCT/KR09/02532

§ 371 Date: Jun. 9, 2011

(30) Foreign Application Priority Data
Dec. 10, 2008 (KR) 10-2008-0125432

(51) Int. Cl. H04L 9/08

(52) U.S. Cl. 380/281; 380/279

(57) ABSTRACT

A group key management method for secure multicast communication includes: creating a tree having a root node, internal nodes and leaf nodes to manage group keys of a receiver group by a group key management server; generating user keys of all nodes excluding the root node in the tree on the basis of Chinese Remainder Theorem; assigning the leaf nodes of the tree to users of the receiver group; and sending the user keys of the leaf nodes to the corresponding users for group key management. Further, the group key management method for secure multicast communication includes generating group keys of all non-leaf nodes; computing a solution of congruence equations based on the user key and group key by using Chinese Remainder Theorem for each non-leaf node; and multicasting a group key update message to each user of the respective leaf nodes.

### TECHNICAL FIELD

The present invention relates to group key management for multicast communication and, more particularly, to a method of group key management for secure multicast communication that enables more secure delivery of group keys only to users having rights during multicast communication on a network in which multiple users can receive the same contents.

### BACKGROUND ART

Multicast transmission generally refers to a network transmission technology that enables multiple users to receive the same contents at the same time. Therefore, when the same contents are served to multiple users, use of multicast transmission can significantly reduce consumption of server resources and network traffic. Meanwhile, any user may join a multicast group and receive data on the network, resulting in security vulnerability.

To solve this problem, secure communication using a group key is utilized for a multicast session. That is, a group of receivers with just rights is formed, and a common group key is given to all receivers of the group. Then, to transmit data, a sender encrypts the data with the common group key and sends the encrypted data.

In such secure transmission with encryption, the sender transmitting data shares an identical group key with multiple receivers needing the data, thereby satisfying security requirements such as data confidentiality and sender authentication.

For secure communication in broadcast or multicast environments, important security requirements are forward secrecy and backward secrecy. Forward secrecy requires that users who left the group are not able to access to any future information related to the group communication using their previous information. Backward secrecy requires that a new user who joins the group is not able to access to any data previously communicated within the group. To ensure forward secrecy and backward secrecy, the group key has to be changed whenever a user joins or leaves the receiver group.

In multicast environments where group keys are shared among multiple users, group key management is more complicated owing to joining and leaving of users than encryption key management in regular one-to-one communication environments, and hence efficiency in group key management is very important.

Performance indicators for efficient group key management include the number of supportable users, storage space to save keys, the number and lengths of messages sent to the network for key updates, and computation time for key updates. The storage space and computation time may be not a very critical factor as of today with enormous performance enhancement of storage devices.

Therefore, to implement group key management on a real system, the number of messages and lengths thereof, which are related to the number of supportable users and efficient utilization of limited network resources, become important performance indicators.

### DISCLOSURE OF INVENTION

### Technical Problem

In view of the above, the present invention provides a group key management method that supports a large number of group members with a minimized number of messages to be sent for secure communication in an environment where data is broadcast or multicast to multiple receivers connected together through a network.

Further, the present invention provides a group key management method for multicast communication that enables multiple group members to share group keys in a safe manner, is readily adaptable tomembership changes due to joining and leaving of member, and permits only current group members to share legitimate group keys.

### Technical Solution

In accordance with an embodiment of the present invention, there is provided a group key management method for secure multicast communication, including: creating a tree having a root node, internal nodes and leaf nodes to manage group keys of a receiver group by a group key management server; generating user keys of all nodes excluding the root node in the tree on the basis of Chinese Remainder Theorem; assigning leaf nodes of the tree to users of the receiver group; sending a set of keys of leaf nodes to the corresponding users for group key management; generating group keys of all non-leaf nodes; computing a solution of congruence equations based on the user keys and group keys by using Chinese Remainder Theorem for each non-leaf node; and multicasting a group key update message to each user of a leaf node.

### Advantageous Effects

In accordance with the present invention, a technical scheme is provided for group key management related to data security in an environment where data is broadcast or multicast to multiple receivers connected together through a network. The scheme provides scalability in terms of the number of users and minimizes the number of messages to be sent for key updates, thereby reducing network-related costs.

### BRIEF DESCRIPTION OF DRAWINGS

The objects and features of the present invention will become apparent from the following description of embodiments given in conjunction with the accompanying drawings, in which:

FIG. 1 illustrates a configuration of a network including a group key management server and receiver group in accordance with an embodiment of the present invention;

FIG. 2 illustrates a receiver group configured as a tree of member subgroups for group key management method in accordance with the embodiment of the present invention;

FIG. 3 illustrates a procedure of group key update in a tree structure in accordance with the embodiment of the present invention;

FIG. 4 is a flow chart of a group key management method for secure multicast communication in accordance with the embodiment of the present invention;

FIG. 5 illustrates a data structure containing user key related information delivered to a receiver in the procedure of FIG. 4;

FIG. 6 is a flow chart of group key generation for tree nodes using Chinese Remainder Theorem in the procedure of FIG. 4;

FIG. 7 is a flow chart of multicasting of a group key update message to the receiver group in the procedure of FIG. 4;

FIG. 8 illustrates the format of a group key update message being multicast in the procedure of FIG. 4;

FIG. 9 is a flow chart of a procedure for group key update when a new user joins a receiver group;

FIG. 10 is a flow chart of a procedure for group key update when a user leaves from a receiver group;

FIG. 11 is a flow chart of a procedure for initialization in a practical group key management method in accordance with the embodiment of the present invention;

FIG. 12 is a flow chart of a procedure for group key update when a new user joins a receiver group in the practical group key management method in accordance with the embodiment of the present invention; and

FIG. 13 is a flow chart of a procedure for group key update when a user leaves from a receiver group in the practical group key management method in accordance with the embodiment of the present invention.

### BEST MODE FOR CARRYING OUT THE INVENTION

Hereinafter, embodiments of the present invention will be described in detail with reference to the accompanying drawings which form a part hereof.

Before the description of the present invention, Chinese Remainder Theorem which is applied to the invention will be explained as follows.

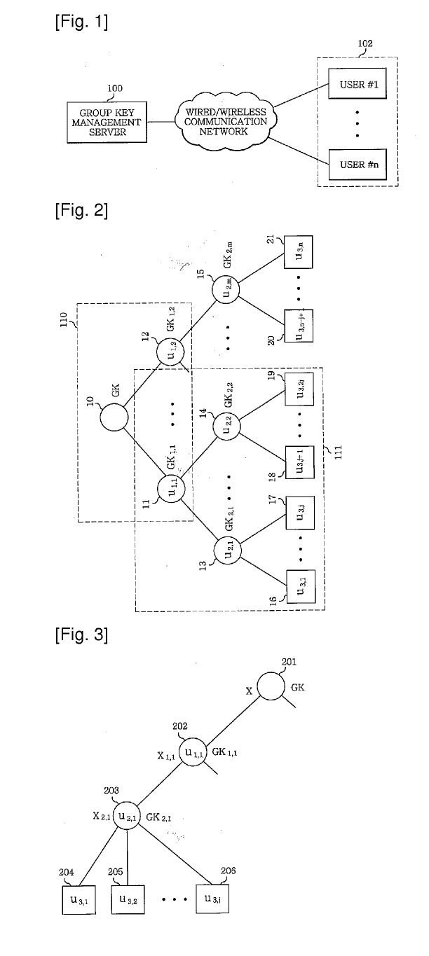

Chinese Remainder Theorem states that for m positive integers u1, . . . , um which are pairwise relative primes and any m integers k₁, . . . , kₘ, there is a solution X which satisfies the following Math Figure 1:

$$\begin{matrix}Math Figure 1 & \\ X ≡ {k}_{1} ( mod {u}_{1} ) \\ … \\ X ≡ {k}_{m} ( mod {u}_{m} ) & [ Math . 1 ]\end{matrix}$$

The solution X to the simultaneous Math Figure 1 can be obtained by Math Figure 2:

$$\begin{matrix}Math Figure 2 & \\ X = {\sum }_{i = 1}^{m} {k}_{i} {M}_{i} {M}_{i}^{′} ( mod M ) , \\ - M = {u}_{1} \times {u}_{2} \times … \times {u}_{m} \\ - {M}_{i} = M / {u}_{i} & [ Math . 2 ]\end{matrix}$$

−Mᵢ′ is a multiplicative inverse of (M₁ mod uᵢ) (i.e., MᵢMᵢ≡1(mod uᵢ))
Group key management method by using Chinese Remainder Theorem may be summarized as follows. User keys enabling extraction of the group key are given to users of the group. The user keys are positive integers being pairwise relative primes and are represented by values u1, . . . , um in the above equations. The sender generates a group key GK, and performs exclusive OR operations on the group key GK and user keys, producing values k1, . . . , km in the above equations (i.e., kᵢ=GK
   ⊕

uᵢ). The sender computes the value X in Math Figure 2 by using ui and ki, and broadcasts or multicasts the value X to the users of the group. Then, each user i divides the value X by the user
key ui to obtain the remainder ki, and performs an exclusive OR operation on the remainder ki and the user key ui to obtain the group key GK. That is, each user i can obtain the group key GK using Math Figure 3:

MathFigure 3

X≡kᵢ(mod uᵢ)

GK computation: kᵢ⊕uᵢ=GK⊕uᵢ⊕uᵢ=GK [Math.3]

Here, users belonging to the receiver group can readily compute the group key GK from the value X, but users not belonging to the receiver group cannot obtain the group key GK because of inability to derive kᵢ values.

When a new user m+1 joins the receiver group of m members, the group key has to be changed for backward secrecy. The sender generates a new user key uₘ₊₁, sends the same to the new user m+1, generates a new group key GK_{new}, computes k₁ to kₘ₊₁ by using user keys u₁ to uₘ₊₁ and the new group key GK_{new}, computes the value X′ by using Math Figure 2 with u₁ to uₘ₊₁ and k₁ to kₘ₊₁, and broadcasts or multicasts the value X′ to the receiver group. Then, users of the receiver group can obtain the new group key GK_{new} by using Math Figure 3.

When a user i leaves the receiver group of m members, the group key has to be updated for forward secrecy. The sender generates a new group key GK_{new}, and computes k₁ to kₘ by using user keys u₁ to uₘ and the new group key GK_{new}. But, the value kᵢ for the left user i is random value other than the value computed by using kᵢ=GK_{new}

⊕

uᵢ. Next, the sender computes the value X′ by using Math Figure 2 with u₁ to uₘ and k₁ to kₘ, and broadcasts or multicasts the value X′ to the receiver group. Then, users of the receiver group can obtain the new group key GK_{new} by using Math Figure 3, however the left user i cannot obtain the new group key GK_{new}.

In group key management method based on Chinese Remainder Theorem, a single multicast message is to be sent for group key update, so that network traffic can be reduced and handling at receivers can be simplified. However, the value X becomes larger with increasing size of the receiver group, and the computation using Math Figure 2 may require a long time. Therefore, this scheme may be adequate for a receiver group of several tens of members, and may be not adequate for a large receiver group.

FIG. 1 illustrates a configuration of a network including a group key management server and receiver group in accordance with an embodiment of the present invention.

As shown in FIG. 1, a group key management server 100 is connected through a network to a receiver group 102 of many users. Particularly, in the present invention, the receiver group 102 is configured as a tree of subgroups having several tens of members, and group key management using Chinese Remainder Theorem is applied to support a large receiver group with a small number of messages and fast computation.

FIG. 2 illustrates a tree structure of subgroups having several tens of members in accordance with the embodiment of the present invention. In the tree, only leaf nodes 16 to 21 are assigned to users, and the root node 10 and internal nodes 11 to 15 are not assigned to users and are dedicated for group key management.

The root node 10 and internal nodes 11 to 15 may have any number of child nodes. Child nodes of a given node become a subgroup to which group key management based on Chinese Remainder Theorem is applied. Hence, the number of child nodes that a particular node is able to have needs to be determined in consideration of the computation time related to Chinese Remainder Theorem, and is preferably less than or equal to 100 considering computer performances as of today.

In the tree, every node excluding the root node 10 has a user key u_{i,j}, and every internal node other than leaf nodes and the root node 10 has a group key GK_{i,j}. In GK_{i,j} and u_{i,j}, i indicates the depth of the associated node in the tree, and j indicates the sequence number of the associated node from left to right.

The root node 10 has a group key GK. A group key assigned to a node is used for communication between the node and descendent nodes of the node. The group key GK owned by the root node 10 is used for multicast communication between the sender and receiver group. Group keys owned by internal nodes are used to update the group key GK.

As described above, child nodes of a given node correspond to a subgroup to which group key management based on Chinese Remainder Theorem is applied. For example, in FIG. 2, each child node of the root node 10, belonging to a subgroup 110, is given a user key based on Chinese Remainder Theorem. Communication between nodes belonging to the subgroup 110 is carried out using the group key GK of the root node 10. Likewise, each child node of the node 11, belonging to a subgroup 111, is given a user key based on Chinese Remainder Theorem. User keys given to nodes in the subgroup 111 are generated independently of those given to nodes in the subgroup 110. In other words, user keys for the subgroup 111 are generated without consideration of those for the subgroup 110. Communication between nodes belonging to the subgroup 111 is carried out using a group key GK_{1,1} of the node 11. The above procedure is repeated to assign user keys and group keys for communication to the remaining nodes.

FIG. 3 illustrates a procedure of group key update in a tree structure. The process of group key update is described in detail below with reference to FIG. 3.

In FIG. 3, only the leftmost subgroup of the tree in FIG. 2 is shown. Group key update is carried out in the same manner for all subgroups, and a description is given to a single subgroup.

In FIG. 3, each leaf node owns user keys u_{i,j} of all ancestor nodes from the leaf node to the root node. The group key management server 100 generates the group key GK2,1 of the node 203, computes the value X (X_{2,1} in this case) in Chinese Remainder Theorem of Math Figure 2 with user keys assigned to child nodes of the node 203, and multicasts the value X_{2,1}. Then, the leaf nodes 204-206 can obtain the group key GK_{2,1}, and other leaf nodes cannot obtain the group key GK_{2,1}.

Next, the group key management server 100 generates the group key GK_{1,1} of the node 202, and computes the value X_{1,1} in Chinese Remainder Theorem of Math Figure 2 with user keys assigned to child nodes of the node 202, where k_{2,i} is calculated using K_{2,i}=GK_{1,1}

⊕

GK_{2,i}

⊕

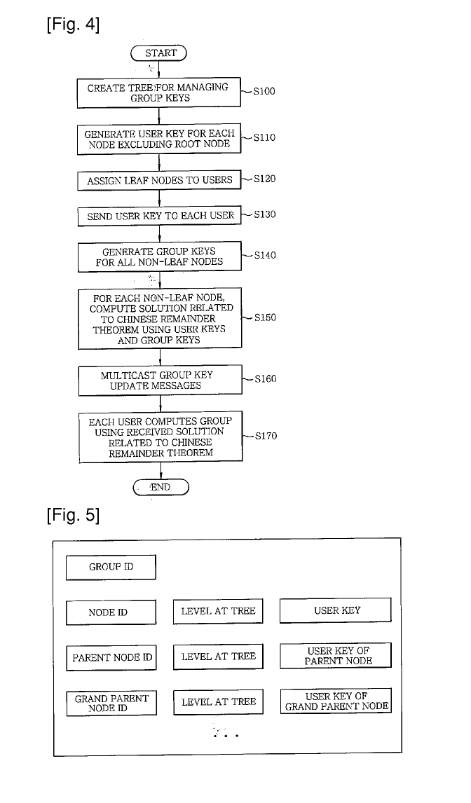

u_{2,i}. The group key management server 100 multicasts the value X_{1,1}. Then, leaf nodes being a descendent of the node 202 can obtain the group key GK_{1,1} using Math Figure 4, and other leaf nodes cannot obtain the group key GK_{1,1}.

MathFigure 4

X_{1,1}≡k_{2,i}(mod u_{2,i}

GK_{1,1} computation at leaf node(3,k):k_{2,i}⊕GK_{2,i}⊕u_{2,i}=GK_{1,1} [Math.4]

Now, each of leaf nodes 204-206 can obtain group keys GK_{1,1} and GK_{2,1}.

Finally, the group key management server 100 generates the group key GK of the root node 201, and computes the value X in Chinese Remainder Theorem of Math FIG. 2 with user keys assigned to child nodes of the node 201, where k_{1,i} is calculated by using k_{1,i}=GK

⊕

GK_{1,i}

⊕

u_{1,i}. The group key management server 100 multicasts the value X. Then, leaf nodes can obtain the group key GK using Math Figure 5.

MathFigure 5

X≡k_{i,j}(mod u_{1,i})

GK computation at leaf node(3,k):k_{1,i}⊕GK_{1,i}⊕u_{1,i}=GK [Math.5]

Through the above procedure, each leaf node owns user keys and group keys of all nodes on the path from the leaf node to the root node. For example, in FIG. 3, the leaf node 204 has user keys u_{3,1}, u_{2,1} and u_{1,1} and group keys GK_{2,1}, GK_{1,1} and GK. For data transmission, the sender encrypts data with the group key GK of the root node 201, and broadcasts or multicasts the encrypted data.

FIG. 4 is a flow chart of a group key management method for secure multicast communication in accordance with an embodiment of the present invention. Next, referring to FIGS. 1, 2, 3 and 4, an embodiment of the present invention is described in detail.

The group key management server 100 creates a tree for managing group keys of the receiver group 102 in step S100. The number of child nodes of each node is preferably determined in consideration of the number of receiver groups and server performance. Each node is given an ID for identification.

The group key management server 100 generates a user key for each node excluding the root node in step S110. In this step, child nodes of a given node are treated as a subgroup and user keys of the child nodes are created to be pair-wise relative primes in connection with Chinese Remainder Theorem. User keys given to child nodes of a node are generated without consideration of those given to child nodes of the other nodes in the tree.

The group key management server 100 assigns a leaf node to one user of the receiver group 102 (in step S120). In this step, a single leaf node is assigned to a single user, and which leaf node is assigned may be arbitrarily determined.

The group key management server 100 sends each user of the receiver group 102 the user key of a leaf node assigned to the user (in step S130). At this time, for a user associated with a leaf node, user keys of all internal nodes on the path from the leaf node to the root node are also sent to the user. That is, a user associated with a leaf node is given the user key of the leaf node and user keys of ancestor nodes of the leaf node.

Thereafter, the group key management server 100 generates group keys for all non-leaf nodes (in step S140). As group keys are used for encrypting data to be multicast or a session key to encrypt data, they may be generated in a form suitable to an encryption algorithm.

The group key management server 100 computes, for each non-leaf node, the solution of simultaneous equations by using user keys and group keys on the basis of Chinese Remainder Theorem in the same manner described in connection with FIG. 3 (in step S150). In this step, lower level nodes are computed first and the computation proceeds in a bottom-up fashion.

The group key management server 100 multicasts group key update messages for nodes (in step S160). At this step, group key update messages related to lower level nodes are sent first and those related to upper level nodes are sent next. Thereafter, each user of the receiver group 102 computes the group key using the received multicast data and its own user key (in step S170).

FIG. 5 illustrates a data structure containing user key related information delivered to a user at step S130 in the procedure of FIG. 4.

Referring to FIG. 5, the data structure containing user key information includes a group ID identifying a receiver group, a node ID assigned to the node, the level of the node at the tree, and a user key for group key management. The data structure may further include node IDs assigned to ancestor nodes such as the parent node, levels of the ancestor nodes at the tree, and user keys of the ancestor nodes. This data structure should be hidden from other users, and hence is encrypted with a secret key shared by the key management server and user or with a public key of the user before transmission.

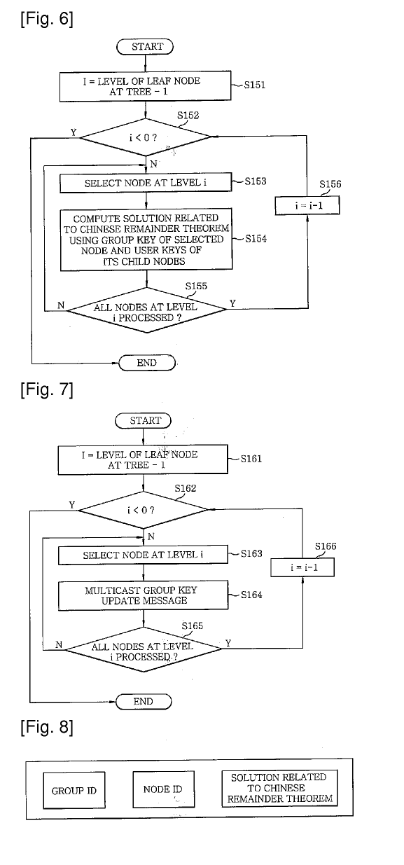

FIG. 6 is a flow chart for computing, for non-leaf nodes, the solution of congruence equations taking user keys and group keys using Chinese Remainder Theorem at step S150 in the procedure of FIG. 4.

First, it is assumed that the level of the root node in the tree is zero and the level of any other node in the tree is one more than the level of its upper node. The group key management server 100 sets an ‘i’ to one less than the level of a leaf node (level of leaf node −1) (in step S151), and checks whether the ‘i’ is less than 0 (S152).

If i is less than 0, the group key management server 100 ends the procedure because the computation related to Chinese Remainder Theorem is complete for all non-leaf nodes.

If i is not less than 0, the group key management server 100 selects a node at level i (in step S153), and computes the solution of simultaneous equations taking the group key of the selected node and user keys of its child nodes on the basis of Chinese Remainder Theorem (in step S154). This computation is carried out in the same manner described in connection with FIG. 3.

After computation related to Chinese Remainder Theorem, the group key management server 100 checks whether all nodes at level i have been processed in relation to Chinese Remainder Theorem (in step S155). If not all nodes at level i have been processed, the group key management server 100 repeats steps S153 to S155 until all nodes at level i have been processed in relation to Chinese Remainder Theorem.

If all nodes at level i have been processed in relation to Chinese Remainder Theorem, the group key management server 100 decrements i by 1 (in step S156), and repeats steps S152 to S155 until all non-leaf nodes are processed in relation to Chinese Remainder Theorem.

FIG. 7 is a flow chart of multicasting of a group key update message to the receiver group at step S160 in the procedure of FIG. 4.

First, it is assumed in the tree that the level of the root node is zero and the level of any other node in the tree is one more than the level of its upper node. The group key management server 100 then sets an ‘i’ to one less than the level of a leaf node (the level of a leaf node −1) (in step S161), and checks whether ‘i’ is less than 0 (in step S162).

If i is less than 0, the group key management server 100 ends the procedure because there is no group key update message to send. If i is not less than 0, the group key management server 100 selects a node at level i (in step S163), and multicasts a group key update message related to the selected node (in step S164).

Thereafter, the group key management server 100 checks whether all nodes at level i have been processed in relation to transmission of group key update messages (in step S165). If not all nodes at level i have been processed, the group key management server 100 repeats steps S163 to S165 until group key update messages for all nodes at level i are multicast.

If all nodes at level i have been processed in relation to transmission of group key update messages, the group key management server 100 decrements i by 1 (S166), and repeats steps S162 to S165 until all non-leaf nodes are processed in relation to transmission of group key update messages.

FIG. 8 illustrates the format of a group key update message being multicast at step S160 in the procedure of FIG. 4.

Referring to FIG. 8, a group key update message includes a group ID to identify a receiver group, a node ID assigned to the node, and the solution of congruence equations for the node computed at step S150.

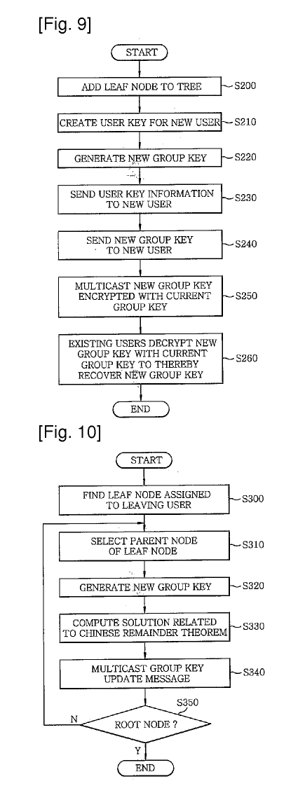

FIG. 9 is a flow chart describing a procedure for group key update when a new user joins a receiver group. The procedure for group key update is described in detail with reference to FIG. 9.

The group key management server 100 adds a leaf node to the tree for the new user (in step S200), creates a user key for the new user (in step S210), and generates a new group key (in step S220).

The group key management server 100 sends user key information as shown in FIG. 5 to the new user (in step S230), and also sends the new group key (in step S240). At this time, for security, the user key information and new group key are encrypted with a secret key shared by the key management server and new user or with a public key of the new user before transmission.

The group key management server 100 encrypts the new group key with the current group key, and multicasts the encrypted new group key (in step S250). At this step, encryption is performed using a symmetric key algorithm such as DES or AES. Thereafter, existing users of the receiver group 102 decrypt the multicast new group key with the current group key to thereby recover the new group key (in step S260).

FIG. 10 is a flow chart of a procedure for group key update when a user leaves from a receiver group.

Referring to FIG. 10, when a user leaves from the receiver group, the group key management server 100 finds a leaf node assigned to the left user in the tree (in step S300), and finds the parent node of the leaf node (in step S310). Here, let's that the parent node is indicated by indices (i, k).

The group key management server 100 generates a new group key GK′i,k for the parent node (in step S320).

The group key management server 100 computes the solution of congruence equations for the parent node on the basis of Chinese Remainder Theorem (in step S330). Here, k_{i+1,j} is computed utilizing user keys u_{i+1,j} of child nodes of the parent node and the new group key, and a value not computed by is used for the left user.

Thereafter, the group key management server 100 multicasts a group key update message as shown in FIG. 8 (in step S340).

The group key management server 100 checks whether the current node is the root node (in step S350). If the current node is the root node, the group key management server 100 ends the procedure. If the current node is not the root node, the group key management server 100 returns to step S310 for processing in relation to the parent node of the current node.

Unlike an existing group key management method based on Chinese Remainder Theorem which can support only several tens of group members, the group key management method described above can support a very large receiver group and requires a small number of group key update messages. However, as the computation related to Chinese Remainder Theorem is required, the computation time for group key update can be long. For more effective key update, the present invention provides a practical group key management method in which computations requiring a long time are performed at the initialization and computations requiring only a short time are carried out at the key update stage.

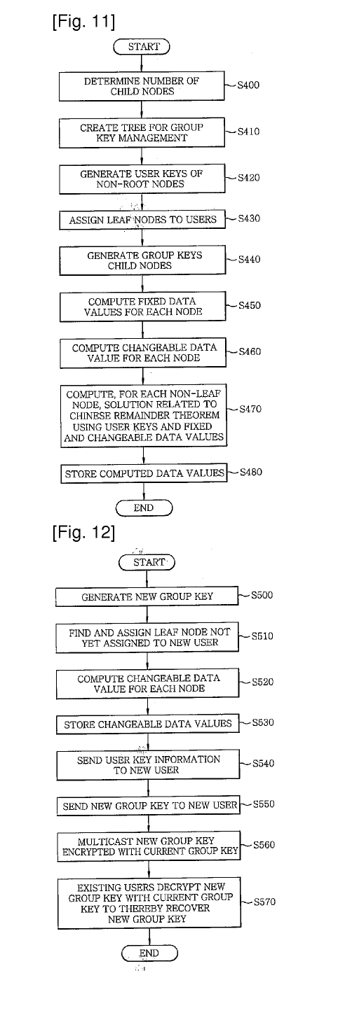

The practical group key management method of the present invention includes an initialization stage and operation stage. FIG. 11 is a flow chart of a procedure for the initialization stage in the practical group key management method.

Referring to FIG. 11, the group key management server 100 determines the number of child nodes for each node (in step S400). The number of child nodes is preferably determined in consideration of the number of users in the receiver group and the computation time. When the number of child nodes is large, the number of group key update messages is small but the required computation time is long. On the other hand, when the number of child nodes is small, the number of group key update messages is large but the required computation time is short. Hence, it is preferable that the number of child nodes is determined considering the number of messages and the computation time.

The group key management server 100 creates a tree on the basis of the number of child nodes determined at step S400 (in step S410). For example, assume that the receiver group can have maximum 100,000 members. If the number of child nodes is determined to be 30, the height of the tree becomes 4 (30×30×30×30=810,000). If the number of child nodes is determined to be 50, the height of the tree becomes 3 (50×50×50=125,000). The number of group key update messages is one less than the depth of the tree. Hence, the number of group key update messages to be sent is three when the number of child nodes is 30, and is two when the number of child nodes is 50.

The group key management server 100 generates user keys of nodes other than the root node (in step S420). Generation of user keys is performed in the same manner as step S110 of FIG. 4.

The group key management server 100 assigns leaf nodes to users in a one-to-one manner (in step S430). In most cases, the number of leaf nodes in a tree is much larger than the number of users, and hence there may exist many leaf nodes not assigned to users.

After leaf node assignment, the group key management server 100 generates group keys for non-leaf nodes (in step S440). Generation of group keys is performed in the same manner as step S140 of FIG. 4.

The group key management server 100 computes fixed data values for each node (in step S450). Here, the fixed data values for each node are values M and NC in Math FIG. 6:

MathFigure 6

M=u₁×u₂× . . . ×uₘ

−u₁ . . . ,uₘ are user keys of child nodes of the node

NC≡MᵢMᵢ′(mod M)

−Mᵢ=M/uᵢ

−Mᵢ′ is an multiplicative inverse of(Mᵢ mod uᵢ)(i.e., MᵢMᵢ′≡1(mod uᵢ)) [Math.6]

The group key management server 100 computes a changeable data value for each node (in step S460). The changeable data value for each node is a value NV in Math Figure 7.

$$\begin{matrix}Math Figure 7 & \\ NV = ( \begin{matrix}{GK}_{i} ⊕ {GK}_{parent} ⊕ {u}_{i} - for non leaf node \\ {GK}_{parent} ⊕ {u}_{i} - for leaf node assigned to a user \\ random value - for leaf node not assigned to a user\end{matrix} ) & [ Math . 7 ]\end{matrix}$$

−GKᵢ: group key assigned to the node

−GKₚₐᵣₑₙₜ: group key assigned to parent node of the node

The group key management server 100 computes, for each non-leaf node, the solution X related to Chinese Remainder Theorem on the basis of the fixed data value NC and changeable data value NV using Math Figure 8 (in step S470).

MathFigure 8

X=Σ(NC×NV)mod M [Math.8]

Thereafter, the group key management server 100 stores the fixed data values NC and changeable data values NV computed at steps S450 and S460 (in step S480).

FIG. 12 is a flow chart of a procedure for group key update when a new user joins during the operation in the practical group key management method.

Referring to FIG. 12, when the new user joins, the group key management server 100 generates a new group key (in step S500), and finds a leaf node not assigned to a user and assigns the found leaf node to the new user (in step S510).

The group key management server 100 computes a changeable data value for each node (in step S520). Computation of changeable data values is performed in the same manner as step S460 of FIG. 11.

The group key management server 100 stores the changeable data value computed at step S520 (in step S530), and sends user key information as shown in FIG. 5 to the new user (in step S540).

The group key management server 100 sends the new group key to the new user (in step S550). Here, for security, the new group key is encrypted with a secret key shared by the key management server 100 and new user or with a public key of the new user before transmission.

The group key management server 100 encrypts the new group key with the current group key, and multicasts the encrypted new group key (in step S560). At this step, encryption is performed using a symmetric key algorithm such as DES or AES. Thereafter, existing users of the receiver group 102 decrypt the multicast new group key with the current group key to thereby recover the new group key (in step S570).

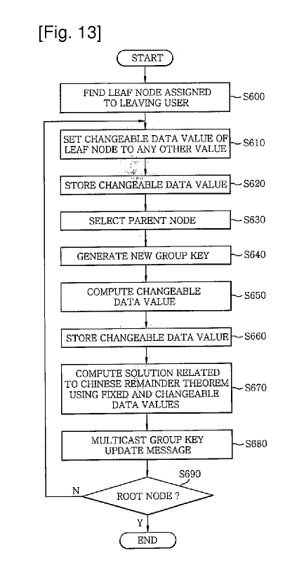

FIG. 13 is a flow chart of a procedure for group key update when a user leaves during the operation in the practical group key management method.

Referring to FIG. 13, the group key management server 100 finds a leaf node assigned to the left user (the current node) in the tree (in step S600), and sets the changeable data value of the found leaf node to any other value (in step S610).

The group key management server 100 stores the new changeable data value of the leaf node (in step S620), and replaces the current node with the parent node of the current node (current node update) (in step S630).

The group key management server 100 generates a new group key of the current node (in step S640), and computes the changeable data value of the current node (in step S650). Computation of the changeable data value is performed in the same manner as step S460 of FIG. 11.

The group key management server 100 stores the computed changeable data value (in step S660), and computes the solution X related to Chinese Remainder Theorem on the basis of the stored fixed data value and changeable data value of the current node (in step S670). Computation of the solution X is performed in the same manner as step S470 of FIG. 11.

The group key management server 100 multicasts a group key update message as shown in FIG. 8 (in step S680).

The group key management server 100 checks whether the current node is the root node (in step S690). If the current node is the root node, the group key management server 100 ends the procedure. If the current node is not the root node, the group key management server 100 returns to step S630 for processing in relation to the parent node of the current node.

The above method of the present invention may be implemented as a computer program, which then can be stored in a computer-readable medium (such as CD-ROM, RAM, ROM, floppy disk, hard disk and magneto-optical disc). This is widely known to those skilled in the art, and is not further detailed.

While the invention has been shown and described with respect to the embodiments, it will be understood by those skilled in the art that various changes and modifications may be made without departing from the scope of the invention as defined in the following claims.

1. A group key management method for secure multicast communication, comprising:
creating a tree having a root node, internal nodes and leaf nodes to manage group keys of a receiver group by a group key management server;
generating user keys of all nodes excluding the root node in the tree on the basis of Chinese Remainder Theorem;
assigning the leaf nodes of the tree to users of the receiver group;
sending a set of keys of the leaf nodes to the corresponding users for group key management;
generating group keys of all non-leaf nodes;
computing a solution of congruence equations based on the user keys and group keys by using Chinese Remainder Theorem for each non-leaf node; and
multicasting a group key update message to each user of the respective leaf nodes.

2. The group key management method of claim 1, wherein each user of the receiver group receives a corresponding group key update message and computes a group key by using data contained in the group key update message and its own user key.

3. The group key management method of claim 1, wherein said computing a solution of congruence equations comprises:
selecting a non-leaf node that is at one level higher than leaf nodes on the tree and does not have an already computed solution related to Chinese Remainder Theorem; and
computing a solution of congruence equations based on a group key of the selected non-leaf node and user keys of child nodes of the selected non-leaf node using Chinese Remainder Theorem.

4. The group key management method of claim 3, wherein computing a solution of congruence equations is repeated until all non-leaf nodes on the tree have a solution of congruence equations related to Chinese Remainder Theorem.

5. The group key management method of claim 1, wherein multicasting a group key update message comprises:
selecting a non-leaf node of the tree for which a group key update message is not yet multicast; and
multicasting the solution related to Chinese Remainder Theorem computed for the selected non-leaf node.

6. The group key management method of claim 5, wherein multicasting a group key update message is repeated until all non-leaf nodes on the tree are handled in relation to solution multicasting.

7. The group key management method of claim 1, wherein the tree divides many users of the receiver group into subgroups with several tens of members.

8. The group key management method of claim 1, wherein the group key update message comprises a group ID to identify a receiver group, a node ID assigned to a node, and a solution of congruence equations related to Chinese Remainder Theorem for the node.

9. A group key management method for secure multicast communication having a procedure of group key update when a new user joins in a receiver group, the method comprising:
adding a leaf node to a tree for a new user in a receiver group by a group key management server;
creating a user key for the new user and a new group key;
sending the created user key and new group key to the new user; and
encrypting the new group key with the current group key and multicasting the encrypted new group key.

10. The group key management method of claim 9, wherein existing users of the receiver group decrypt the multicast new group key with the current group key to thereby recover the new group key.

11. A group key management method for secure multicast communication having a procedure of group key update when a user leaves from a receiver group, the method comprising:
finding a leaf node assigned to the user left from the receiver group in a tree by a group key management server;
selecting the parent node of the found leaf node, and generating a new group key for the parent node;
computing a solution of congruence equations for the parent node on the basis of Chinese Remainder Theorem; and
multicasting a group key update message related to the new group key.

12. The group key management method of claim 11, wherein the group key management server repeats generation and multicasting of a new group key for an ancestor node of the parent node in a bottom-up fashion until the ancestor node is the root node of the tree.

13. A group key management method for practical secure multicast communication, comprising:
determining the number of child nodes that a particular node is allowed to have in a receiver group by a group key management server;
creating a tree according to the determined number of child nodes;
generating user keys of all nodes other than the root node in the tree on the basis of Chinese Remainder Theorem;
assigning leaf nodes to users of the receiver group in a one-to-one manner;
generating group keys for non-leaf nodes in the tree;
computing fixed and changeable data values for each node in the tree;
computing, using fixed and changeable data values of each node in the tree, a solution of congruence equations related to Chinese Remainder Theorem; and
storing the fixed and changeable data values.

14. A group key management method for practical secure multicast communication having a procedure of group key update when a user joins a receiver group, the method comprising:
creating a new group key for the new user in a receiver group by a group key management server;
finding a leaf node of a tree not assigned to a user and assigning the found leaf node to the new user;
computing and storing a changeable data value for the leaf node;
sending user key information and the new group key to the new user; and
encrypting the new group key with the current group key and multicasting the encrypted new group key.

15. The group key management method of claim 14, wherein existing users of the receiver group decrypt the multicast new group key with the current group key to thereby recover the new group key.

16. A group key management method for practical secure multicast communication having a procedure of group key update when a user leaves from a receiver group, the method comprising:
finding a leaf node assigned to the left user in a tree of the receiver group by a group key management server;
setting a changeable data value of the leaf node to any other value and storing the changeable data value;
selecting a parent node of the leaf node and generating a new group key for the parent node;
computing and storing a changeable data value for the parent node;
computing a solution of congruence equations related to Chinese Remainder Theorem on the basis of the stored fixed data value and changeable data value of the parent node; and
multicasting a group key update message containing the new group key.

17. The group key management method of claim 16, wherein the group key management server repeats generation and multicasting of a new group key for an ancestor node of the parent node in a bottom-up fashion until the ancestor node is the root node of the tree.
